(19) United States
(12) Patent Application Publication
(10) Pub. No.: US 2017/0261873 A1
(43) Pub. Date: Sep. 14, 2017

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventor: Michinori FUKUMA, Ebina-shi (JP)

(73) Assignee: FUJI XEROX CO., LTD., Tokyo (JP)

(21) Appl. No.: 15/241,016

(22) Filed: Aug. 18, 2016

(30) Foreign Application Priority Data
Mar. 8, 2016 (JP) 2016-044848

(51) Int. Cl. G03G 15/00

(52) U.S. Cl. CPC G03G 5/08; G03G 21/18

(57) ABSTRACT

An electrophotographic photoreceptor includes: a conductive substrate; a charge generation layer that is disposed on the conductive substrate and contains a resin, a phthalocyanine pigment, and a compound represented by the following Formula (BP); and a charge transport layer that is disposed on the charge generation layer and contains a charge transport material,

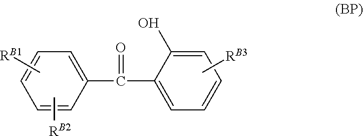

wherein R^{B1}, R^{B2} and R^{B3} each independently represent a hydrogen atom, a halogen atom, a hydroxyl group, an alkyl group having from 1 to 10 carbon atoms, an alkoxy group having from 1 to 10 carbon atoms, or an aryl group having from 6 to 10 carbon atoms.

### CROSS-REFERENCE TO RELATED APPLICATIONS

This application is based on and claims priority under 35 USC 119 from Japanese Patent Application No. 2016-044848 filed on Mar. 8, 2016.

### BACKGROUND

(i) Technical Field

The present invention relates to an electrophotographic photoreceptor, a process cartridge, and an image forming apparatus.

(ii) Related Art

Apparatuses that sequentially performs processes such as charging, electrostatic latent image formation, developing, transfer, and cleaning using an electrophotographic photoreceptor (hereinafter, may be referred to as “photoreceptor”) have been widely known as an electrophotographic image forming apparatus.

As the electrophotographic photoreceptor, a function separation-type photoreceptor in which a charge generation layer that generates electric charges and a charge transport layer that transports electric charges are laminated on a conductive substrate such as aluminum, or a single layer-type photoreceptor in which the same layer serves a charge generation function and a charge transport function has been known.

### SUMMARY

According to an aspect of the invention, there is provided an electrophotographic photoreceptor comprising: a conductive substrate; a charge generation layer that is disposed on the conductive substrate and comprises a resin, a phthalocyanine pigment, and a compound represented by the following Formula (BP); and a charge transport layer that is disposed on the charge generation layer and comprises a charge transport material,

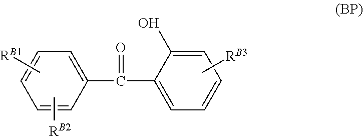

wherein R^{B1}, R^{B2} and R^{B3} each independently represent a hydrogen atom, a halogen atom, a hydroxyl group, an alkyl group having from 1 to 10 carbon atoms, an alkoxy group having from 1 to 10 carbon atoms, or an aryl group having from 6 to 10 carbon atoms.

### BRIEF DESCRIPTION OF THE DRAWINGS

Exemplary embodiments of the present invention will be described in detail based on the following figures, wherein:

FIG. 1 is a schematic partial cross-sectional view illustrating an example of a layer configuration of an electrophotographic photoreceptor according to an exemplary embodiment;

FIG. 2 is a schematic configuration diagram illustrating an example of an image forming apparatus according to an exemplary embodiment; and

FIG. 3 is a schematic configuration diagram illustrating another example of an image forming apparatus according to an exemplary embodiment.

### DETAILED DESCRIPTION

Hereinafter, exemplary embodiments of the invention will be described with reference to the accompanying drawings. In the drawings, elements having the same function will be denoted by the same reference numerals, and redundant description thereof will be omitted.

### Electrophotographic Photoreceptor

An electrophotographic photoreceptor according to this exemplary embodiment (hereinafter, also referred to as “photoreceptor”) has a conductive substrate, a charge generation layer that is disposed on the conductive substrate and contains a phthalocyanine pigment and a compound represented by the following Formula (BP), and a charge transport layer that is disposed on the charge generation layer and contains a charge transport material.

Hereinafter, the compound represented by Formula (BP) may be called “specific benzophenone compound”.

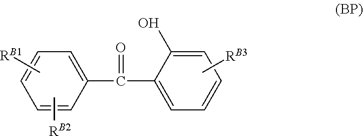

In the above Formula (BP), R^{B1}, R^{B2}, and R^{B3} each independently represent a hydrogen atom, a halogen atom, a hydroxyl group, an alkyl group having from 1 to 10 carbon atoms, an alkoxy group having from 1 to 10 carbon atoms, or an aryl group having from 6 to 10 carbon atoms.

Due to the above-described configuration, the electrophotographic photoreceptor according to this exemplary embodiment prevents a phenomenon in which the history of a previous image remains on an image (positive ghost). The reason for this is presumed as follows.

In the image formation using a function separation-type photoreceptor having a charge generation layer and a charge transport layer, for example, after charging of a surface of the photoreceptor, an electric charge having a potential opposite to that of the surface of the photoreceptor is generated in the charge generation layer by exposure, and thus the potential of the surface of the photoreceptor is negated by the opposite charge, and an electrostatic latent image is formed. Specifically, for example, after the surface of the photoreceptor is negatively charged, a positive charge is generated in the charge generation layer by exposing an image part, a large amount of the generated positive charge is transported to the surface of the photoreceptor by a charge transport material in the charge transport layer, and thus the potential in the image part on the surface of the photoreceptor is negated.

However, a part of the electric charge generated in the charge generation layer may remain by exposure in the charge generation layer or in the interface between the charge generation layer and the charge transport layer. Particularly, a phthalocyanine pigment is thought to generate an electric charge with an intrinsic mechanism, and when a phthalocyanine pigment is used as a charge generation material, the electric charge remains in the layer or in the interface more easily than in a case using a charge generation material with an extrinsic charge generation mechanism.

When a subsequent image is formed in a state in which a part of the electric charge remains in the layer or in the interface, the residual charge is moved to the surface after charging of the surface of the photoreceptor, the photoreceptor surface potential in that region is negated, and thus an electrostatic latent image on which the history of the previous image remains is formed and a positive ghost occurs in some cases.

In contrast, in this exemplary embodiment, a phthalocyanine pigment is used as a charge generation material, and the charge generation material includes, in addition to the phthalocyanine pigment, a specific benzophenone compound.

Here, the specific benzophenone compound is a compound that is generally used as an ultraviolet absorber in many cases. Specifically, for example, the specific benzophenone compound is used for the purpose of preventing ultraviolet rays from reaching the inside of a photosensitive layer by adding the specific benzophenone compound as an ultraviolet absorber to a layer (a layer near the surface) that is easily exposed to the ultraviolet rays among layers of a photoreceptor.

However, in this exemplary embodiment, since the specific benzophenone compound is added to the charge generation layer that is distant from the surface, and the phthalocyanine pigment is used as a charge generation material, the positive ghost is prevented. The mechanism by which the positive ghost is prevented is not clear, but is assumed to be that due to an interaction between the phthalocyanine pigment and the specific benzophenone compound, the movement of the electric charge generated by the phthalocyanine pigment to the charge transport material is promoted, and thus the remaining charge in the layer or in the interface is prevented.

Particularly, since the specific benzophenone compound has a 2-hydroxy group, the specific benzophenone compound is thought to have an effect of reducing the residual charge in the charge generation layer and the charge transport layer in comparison to another benzophenone compound having no 2-hydroxy group. For example, in a charge generation layer containing a benzophenone compound having an amino group, the positive ghost may become relatively inconspicuous since the electric charge remains due to the trapping of the electric charge by the amino group, and as a result, image defects may be prevented. However, in the charge generation layer having the specific benzophenone compound, the remaining charge in the layer or in the interface is prevented as described above, and it is thought that the positive ghost is prevented with a mechanism completely different from that of the charge generation layer containing a benzophenone compound having an amino group.

Due to the above reasons, the electrophotographic photoreceptor according to this exemplary embodiment is assumed to prevent a phenomenon in which the history of a previous image remains on an image (positive ghost).

Furthermore, when the same image is continuously formed (for example, continuous formation on 3,000 sheets of paper) on a photoreceptor in which a positive ghost easily occurs, the surface potential of the photoreceptor in the region exposed continuously may be reduced. Thereafter, for example, when a front half-tone image is formed, a phenomenon in which the image density in the region exposed continuously is increased (burning ghost) may occur.

In the photoreceptor in which a positive ghost easily occurs, even in a case in which the photoreceptor is exposed to light such as indoor light or sunlight, the electrostatic properties of the photoreceptor in the light-exposed part are easily reduced. Thereafter, for example, when a front half-tone image is formed, a phenomenon in which the image density in the light-exposed region is increased (optical fatigue) may occur.

However, in this exemplary embodiment, as described above, the remaining charge is prevented by the presence of the specific benzophenone compound, and thus a burning ghost and optical fatigue are also prevented in addition to the positive ghost.

Hereinafter, the electrophotographic photoreceptor according to this exemplary embodiment will be described with reference to the drawing.

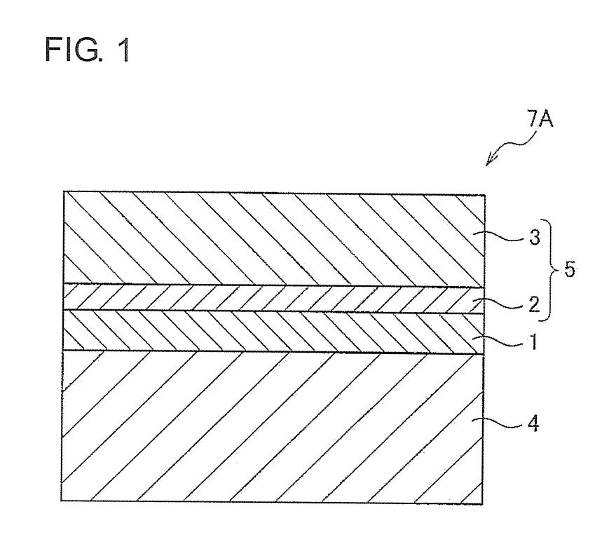

FIG. 1 is a schematic partial cross-sectional view illustrating an example of a layer configuration of an electrophotographic photoreceptor 7A according to this exemplary embodiment. The electrophotographic photoreceptor 7A illustrated in FIG. 1 has a structure in which an undercoat layer 1, a charge generation layer 2, and a charge transport layer 3 are laminated in this order on a conductive substrate 4. A photosensitive layer 5 includes the charge generation layer 2 and the charge transport layer 3.

The electrophotographic photoreceptor 7A may have a layer configuration in which the undercoat layer 1 is not provided. The electrophotographic photoreceptor 7A may have a layer configuration in which a protective layer is further provided on the charge transport layer 3.

Hereinafter, the layers of the electrophotographic photoreceptor according to this exemplary embodiment will be described in detail. The description will be given without the reference numerals.

### Conductive Substrate

Examples of the conductive substrate include metal plates, metal drums, and metal belts containing a metal (such as aluminum, copper, zinc, chromium, nickel, molybdenum, vanadium, indium, gold, and platinum) or an alloy (such as stainless steel). Other examples of the conductive substrate include paper, resin films, and belts on which a conductive compound (such as conductive polymer and indium oxide), a metal (such as aluminum, palladium, and gold), or an alloy is coated, deposited, or laminated. Here, the term “conductive” means that the volume resistivity is less than 10¹³ Ωcm.

In a case in which the electrophotographic photoreceptor is used in a laser printer, the conductive substrate preferably has a roughened surface in which a center-line average roughness Ra is from 0.04 μm to 0.5 μm in order to prevent an interference fringe occurring during the laser irradiation. In a case in which incoherent light is used as a light source, roughening for preventing an interference fringe is not particularly required, but is suitable for increasing a lifetime since the generation of defects by irregularities of the surface of the conductive substrate is prevented.

Examples of the roughening method include wet honing that is performed by spraying a suspension obtained by suspending an abrasive in water onto a conductive substrate, centerless grinding in which a conductive substrate is pressed against rotating grinding stone and is continuously ground, and an anodization treatment.

As the roughening method, a method in which a layer is formed on a surface of a conductive substrate by dispersing a conductive or semiconductive powder in a resin, and roughening is performed with the particles dispersed in the layer without roughening of the surface of the conductive substrate is also exemplified. An undercoat layer to be described later may also be used as the layer for roughening.

In the roughening treatment using anodization, anodization is performed in an electrolyte solution with a conductive substrate made of a metal (for example, made of aluminum) as an anode, and thus an oxide film is formed on a surface of the conductive substrate. Examples of the electrolyte solution include a sulfuric acid solution and an oxalic acid solution. However, the porous anodic oxide film itself formed by the anodization is chemically active and is easily contaminated, and the resistance variation thereof due to the environment is also large. Accordingly, the porous anodic oxide film is preferably subjected to a sealing treatment for changing into a more stable hydrated oxide in a manner such that fine holes of the oxide film are blocked by volume expansion caused by a hydration reaction in steam under pressure or in boiling water (a metal salt such as nickel may be added).

The anodic oxide film preferably has a thickness of, for example, from 0.3 μm to 15 μm. When the thickness is within the above range, there is a tendency that barrier properties may be exhibited with respect to the injection, and an increase in the residual potential due to repeated use may be prevented.

The conductive substrate may be treated using an acidic treatment liquid or may be subjected to a boehmite treatment.

The treatment using an acidic treatment liquid is performed, for example, as follows. First, an acidic treatment liquid is prepared containing a phosphoric acid, a chromic acid, and a hydrofluoric acid. Regarding the blending ratio of the phosphoric acid, the chromic acid, and the hydrofluoric acid in the acidic treatment liquid, for example, the phosphoric acid may be in a range from 10% by weight to 11% by weight, the chromic acid may be in a range from 3% by weight to 5% by weight, and the hydrofluoric acid may be in a range from 0.5% by weight to 2% by weight. The concentration of all of these acids may be in a range from 13.5% by weight to 18% by weight. The treatment temperature is preferably, for example, from 42° C. to 48° C. The thickness of the coating is preferably from 0.3 μm to 15 μm.

The boehmite treatment is performed through dipping for from 5 minutes to 60 minutes in pure water at from 90° C. to 100° C., or coming into contact with heated water vapor at from 90° C. to 120° C. for from 5 minutes to 60 minutes. The thickness of the coating is preferably from 0.1 μm to 5 μm. An anodization treatment may be further performed thereon using an electrolyte solution having low coating dissolving properties, such as an adipic acid, a boric acid, a borate, a phosphate, a phthalate, a maleate, a benzoate, a tartrate, or a citrate.

### Undercoat Layer

The undercoat layer is, for example, a layer containing inorganic particles and a binder resin.

As the inorganic particles, inorganic particles having a powder resistance (volume resistivity) of from 10² Ωcm to 10¹¹ Ωcm are exemplified.

Among these, as the inorganic particles having the resistance value, metal oxide particles such as tin oxide particles, titanium oxide particles, zinc oxide particles, and zirconium oxide particles may be used, and zinc oxide particles are particularly preferred.

The specific surface area of the inorganic particles that is obtained by a BET method may be, for example, 10 m²/g or greater.

The volume average particle diameter of the inorganic particles may be, for example, from 50 nm to 2,000 nm (preferably from 60 nm to 1,000 nm).

The content of the inorganic particles is, for example, preferably from 10% by weight to 80% by weight, and more preferably from 40% by weight to 80% by weight with respect to the binder resin.

The inorganic particles may be subjected to a surface treatment. Two or more kinds of inorganic particles subjected to different surface treatments or having different particle diameters may be mixed and used.

Examples of the surface treatment agent include silane coupling agents, titanate coupling agents, aluminum coupling agents, and surfactants. Particularly, silane coupling agents are preferred, and silane coupling agents having an amino group are more preferred.

Examples of the silane coupling agents having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

Two or more kinds of silane coupling agents may be mixed and used. For example, a silane coupling agent having an amino group and other silane coupling agents may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any one of known methods, and may be either a dry method or a wet method.

The amount of the surface treatment agent for the treatment is, for example, preferably from 0.5% by weight to 10% by weight with respect to the inorganic particles.

Here, inorganic particles and an electron accepting compound (acceptor compound) may be contained in the undercoat layer from the viewpoint of superior long-term stability of electrical characteristics and carrier blocking properties.

Examples of the electron accepting compound include electron transport materials such as quinone compounds such as chloranil and bromanil; tetracyanoquinodimethane compounds; fluorenone compounds such as 2,4,7-trinitrofluorenone and 2,4,5,7-tetranitro-9-fluorenone; oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone compounds; thiophene compounds; and diphenoquinone compounds such as 3,3′,5,5′-tetra-t-butyldiphenoquinone.

Particularly, as the electron accepting compound, compounds having an anthraquinone structure are preferred. Preferable examples of the compounds having an anthraquinone structure include hydroxyanthraquinone compounds, aminoanthraquinone compounds, and aminohydroxyanthraquinone compounds, and specifically, anthraquinone, alizarin, quinizarin, anthrarufin, purpurin, and the like are preferred.

The electron accepting compound may be contained as dispersed with the inorganic particles in the undercoat layer, or may be contained as attached to the surfaces of the inorganic particles.

Examples of the method of attaching the electron accepting compound to the surfaces of the inorganic particles include a dry method and a wet method.

The dry method is a method of attaching the electron accepting compound to the surfaces of the inorganic particles, in which the electron accepting compound is added dropwise to the inorganic particles or sprayed thereto together with dry air or nitrogen gas, either directly or in the form of a solution in which the electron accepting compound is dissolved in an organic solvent, while the inorganic particles are stirred with a mixer or the like having a high shearing force. The dropwise addition or spraying of the electron accepting compound may be performed at a temperature not higher than the boiling point of the solvent. After the dropwise addition or spraying of the electron accepting compound, baking at a temperature of 100° C. or higher may be further performed. The baking is not particularly limited as long as the temperature and the time are set such that electrophotographic characteristics are obtained.

The wet method is a method of attaching the electron accepting compound to the surfaces of the inorganic particles, in which while the inorganic particles are dispersed in a solvent by means of stirring, ultrasonic waves, a sand mill, an attritor, a ball mill, or the like, the electron accepting compound is added, the mixture is stirred or dispersed, and then the solvent is removed. As a method of removing the solvent, for example, the solvent is removed by filtering or distillation. After removing the solvent, the particles may further be subjected to baking at a temperature of 100° C. or higher. The baking is not particularly limited as long as the temperature and the time are set such that electrophotographic characteristics are obtained. In the wet method, the moisture contained in the inorganic particles may be removed before the addition of the electron accepting compound, and examples of the method of removing the moisture include a method of removing the moisture by stirring and heating in the solvent or by azeotropic removal with the solvent.

The attachment of the electron accepting compound may be performed before or after the inorganic particles are subjected to the surface treatment using a surface treatment agent, or the attachment of the electron accepting compound may be performed at the same time with the surface treatment using a surface treatment agent.

The content of the electron accepting compound may be, for example, from 0.01% by weight to 20% by weight, and is preferably from 0.01% by weight to 10% by weight with respect to the inorganic particles.

Examples of the binder resin used in the undercoat layer include known materials, such as known polymeric compounds such as acetal resins (such as polyvinylbutyral), polyvinyl alcohol resins, polyvinyl acetal resins, casein resins, polyimide resins, cellulose resins, gelatins, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins; zirconium chelate compounds; titanium chelate compounds; aluminum chelate compounds; titaniumalkoxide compounds; organic titanium compounds; and silane coupling agents.

Other examples of the binder resin used in the undercoat layer include charge transport resins having a charge transport group, and conductive resins (such as polyaniline).

Among these, as the binder resin used in the undercoat layer, a resin that is insoluble in a coating solvent of an upper layer is suitable, and particularly, thermosetting resins such as urea resins, phenol resins, phenol-formaldehyde resins, melamine resins, urethane resins, unsaturated polyester resins, alkyd resins, and epoxy resins; and resins obtained by a reaction of a curing agent and at least one kind of resin selected from the group consisting of polyamide resins, polyester resins, polyether resins, methacrylic resins, acrylic resins, polyvinyl alcohol resins, and polyvinyl acetal resins are suitable.

In a case in which these binder resins are used in combination of two or more kinds thereof, the mixing ratio is set as appropriate.

Various additives may be contained in the undercoat layer to improve electrical characteristics, environmental stability, and image quality.

Examples of the additives include known materials such as electron transport pigments such as polycondensed types and azo types, zirconium chelate compounds, titanium chelate compounds, aluminum chelate compounds, titanium alkoxide compounds, organic titanium compounds, and silane coupling agents. The silane coupling agent may be used for the surface treatment of the inorganic particles as described above, but may also be added to the undercoat layer as an additive.

Examples of the silane coupling agent as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethylmethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethylacetoacetate, zirconium triethanolamine, acetylacetonate zirconium butoxide, ethylacetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetranormalbutyl titanate, butyl titanate dimer, tetra(2-ethylhexyl) titanate, titanium acetyl acetonate, polytitaniumacetyl acetonate, titanium octylene glycolate, titanium lactate ammonium salt, titanium lactate, titanium lactate ethyl ester, titanium triethanol aminate, and polyhydroxy titanium stearate.

Examples of the aluminum chelate compounds include aluminum isopropylate, monobutoxy aluminum diisopropylate, aluminum butylate, diethylacetoacetate aluminum diisopropylate, and aluminum tris(ethylacetoacetate).

These additives may be used alone or as a mixture or a polycondensate of plural kinds of compounds.

The Vickers hardness of the undercoat layer may be 35 or more.

The surface roughness of the undercoat layer (ten point average roughness) may be adjusted in a range from 1/(4n) (n is a refractive index of the upper layer) to 1/2 of a wavelength λ of the laser for exposure to be used, in order to prevent a moire fringe.

Resin particles and the like may be added in the undercoat layer in order to adjust the surface roughness. Examples of the resin particles include silicone resin particles and crosslinked polymethyl methacrylate resin particles. In addition, the surface of the undercoat layer may be polished in order to adjust the surface roughness. Examples of the polishing method include buffing polishing, a sandblasting treatment, wet honing, and a grinding treatment.

The formation of the undercoat layer is not particularly limited, and well-known forming methods are used. For example, the formation of the undercoat layer is performed by forming a coating film of a coating liquid for forming an undercoat layer, obtained by adding the components to a solvent, and drying the coating film, followed by heating, if necessary.

Examples of the solvent for preparing the coating liquid for forming an undercoat layer include known organic solvents such as alcohol solvents, aromatic hydrocarbon solvents, halogenated hydrocarbon solvents, ketone solvents, ketone alcohol solvents, ether solvents, and ester solvents.

Specific examples of these solvents include usual organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in preparing the coating liquid for forming an undercoat layer include known methods such as methods using a roll mill, a ball mill, a vibration ball mill, an attritor, a sand mill, a colloid mill, a paint shaker, and the like.

Examples of the method of coating the conductive substrate with the coating liquid for forming an undercoat layer include usual methods such as a blade coating method, a wire bar coating method, a spray coating method, a dipping coating method, a bead coating method, an air knife coating method, and a curtain coating method.

The thickness of the undercoat layer is set in a range of, for example, preferably 15 μm or more, and more preferably from 18 μm to 50 μm.

### Intermediate Layer

Although not shown in the drawings, an intermediate layer may be further provided between the undercoat layer and the photosensitive layer.

The intermediate layer is, for example, a layer containing a resin. Examples of the resin used in the intermediate layer include polymeric compounds such as acetal resins (such as polyvinylbutyral), polyvinyl alcohol resins, polyvinyl acetal resins, casein resins, polyamide resins, cellulose resins, gelatins, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer containing an organic metal compound. Examples of the organic metal compound used in the intermediate layer include organic metal compounds containing a metal atom such as zirconium, titanium, aluminum, manganese, and silicon.

These compounds used in the intermediate layer may be used alone or as a mixture or a polycondensate of plural kinds of compounds.

Among these, layers containing an organic metal compound containing a zirconium atom or a silicon atom are preferred as the intermediate layer.

The formation of the intermediate layer is not particularly limited, and well-known forming methods are used. For example, the formation of the intermediate layer is performed by forming a coating film of a coating liquid for forming an intermediate layer, obtained by adding the components to a solvent, and drying the coating film, followed by heating, if necessary.

As the coating method for forming the intermediate layer, usual methods such as a dipping coating method, an extrusion coating method, a wire bar coating method, a spray coating method, a blade coating method, a knife coating method, and a curtain coating method are used.

The thickness of the intermediate layer is preferably set in a range, for example, from 0.1 μm to 3 μm. Further, the intermediate layer may be used as an undercoat layer.

### Charge Generation Layer

The charge generation layer is, for example, a layer containing a charge generation material and a binder resin.

A phthalocyanine pigment is applied as the charge generation material.

In the charge generation layer containing a phthalocyanine pigment, a compound (specific benzophenone compound) represented by Formula (BP) is further contained.

### Charge Generation Material

The phthalocyanine pigment is not particularly limited as long as it is a pigment having a phthalocyanine skeleton. In general, phthalocyanine pigments have several kinds of crystal forms, and any of the crystal forms may be used as long as it is a crystal form by which a target sensitivity is obtained.

Examples of the phthalocyanine pigment that is particularly preferably used include chlorogallium phthalocyanine, dichloro-tin phthalocyanine, hydroxygallium phthalocyanine, metal-free phthalocyanine, titanyl phthalocyanine, and chloroindium phthalocyanine.

Among these, metal phthalocyanine pigments or metal-free phthalocyanine pigments are preferably used as the charge generation material in order to be adaptable to laser exposure in the near-infrared region. Specifically, for example, hydroxygallium phthalocyanine; chlorogallium phthalocyanine; dichloro-tin phthalocyanine; and titanyl phthalocyanine are more preferred.

Among these, hydroxygallium phthalocyanine pigments are preferred, and V-type hydroxygallium phthalocyanine pigments are more preferred as the charge generation material from the viewpoint of charge generation efficiency.

Particularly, as the hydroxygallium phthalocyanine pigments, for example, hydroxygallium phthalocyanine pigments having a maximum peak wavelength in a range from 810 nm to 839 nm in a spectral absorption spectrum in a wavelength region of from 600 nm to 900 nm are preferred from the viewpoint of obtaining more excellent dispersibility.

The hydroxygallium phthalocyanine pigments having a maximum peak wavelength in a range from 810 nm to 839 nm preferably has an average particle diameter in a specific range and a BET specific surface area in a specific range. Specifically, the average particle diameter is preferably 0.20 μm or less, and more preferably from 0.01 μm to 0.15 μm. The BET specific surface area is preferably 45 m²/g or greater, more preferably 50 m²/g or greater, and particularly preferably from 55 m²/g to 120 m²/g. The average particle diameter is a volume average particle diameter (d50 average particle diameter) and is a value measured by a laser diffraction scattering particle diameter distribution measuring device (LA-700, manufactured by Horiba, Ltd.). In addition, the BET specific surface area is a value measured by a nitrogen substitution method using a BET specific surface area measuring device (manufactured by Shimadzu Corporation: FLOW SORB 112300).

The maximum particle diameter (a maximum value of a primary particle diameter) of the hydroxygallium phthalocyanine pigment is preferably 1.2 μm or less, more preferably 1.0 μm or less, and even more preferably 0.3 μm or less.

The hydroxygallium phthalocyanine pigment preferably has an average particle diameter of 0.2 μm or less, a maximum particle diameter of 1.2 μm or less, and a specific surface area of 45 m²/g or greater.

The hydroxygallium phthalocyanine pigment is preferably a V-type hydroxygallium phthalocyanine pigment showing diffraction peaks at at least 7.3°, 16.0°, 24.9°, and 28.0° by a Bragg angle (2θ±0.2°) in an X-ray diffraction spectrum obtained using CuKα characteristic X-ray.

The phthalocyanine pigments may be used alone or in combination of two or more kinds thereof.

As the charge generation material, charge generation materials other than the phthalocyanine pigment may be used in combination. Examples of other charge generation materials include azo pigments such as bisazo and trisazo pigments; condensed aromatic pigments such as dibromoanthanthrone; perylene pigments; pyrrolopyrrole pigments; zinc oxides; and trigonal selenium.

The content of the charge generation material in the whole charge generation layer is preferably from 10% by weight to 90% by weight, more preferably from 40% by weight to 80% by weight, and even more preferably from 50% by weight to 70% by weight from the viewpoint of the prevention of a positive ghost and charge generation efficiency.

### Specific Benzophenone Compound

The charge generation layer contains a compound (specific benzophenone compound) represented by the following Formula (BP) as well as the charge generation material.

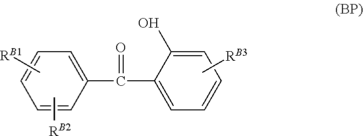

In Formula (BP), R^{B1}, R^{B2}, and R^{B3} each independently represent a hydrogen atom, a halogen atom, a hydroxyl group, an alkyl group having from 1 to 10 carbon atoms, an alkoxy group having from 1 to 10 carbon atoms, or an aryl group having from 6 to 10 carbon atoms.

In Formula (BP), as the halogen atom represented by R^{B1}, R^{B2}, and R^{B3}, a fluorine atom, a chlorine atom, a bromine atom, an iodine atom, and the like are exemplified. Among these, a fluorine atom and a chlorine atom are preferred, and a chlorine atom is more preferred as the halogen atom.

In Formula (BP), as the alkyl group represented by R^{B1}, R^{B2}, and R^{B3}, a linear or branched alkyl group having from 1 to 10 carbon atoms (preferably from 1 to 6, and more preferably from 1 to 4) is exemplified.

Specific examples of the linear alkyl group include a methyl group, an ethyl group, an n-propyl group, an n-butyl group, an n-pentyl group, an n-hexyl group, an n-heptyl group, an n-octyl group, an n-nonyl group, and an n-decyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Among these, lower alkyl groups such as a methyl group, an ethyl group, and an isopropyl group are preferred as the alkyl group.

In Formula (BP), as the alkoxy group represented by R^{B1}, R^{B2}, and R^{B3}, a linear or branched alkoxy group having from 1 to 10 carbon atoms (preferably from 1 to 6, and more preferably from 1 to 4) is exemplified.

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Among these, a methoxy group is preferred as the alkoxy group.

In Formula (BP), as the aryl group represented by R^{B1}, R^{B2}, and R^{B3}, an aryl group having from 6 to 10 carbon atoms (preferably from 6 to 9, and more preferably from 6 to 8) is exemplified.

Specific examples of the aryl group include a phenyl group and a naphthyl group.

Among these, a phenyl group is preferred as the aryl group.

In Formula (BP), the substituents represented by R^{B1}, R^{B2}, and R^{B3} also include a group further having a substituent. Examples of this substituent include the atoms and groups exemplified in the above description (such as a halogen atom, a hydroxyl group, an alkyl group, an alkoxy group, and an aryl group).

In Formula (BP), from the viewpoint of the prevention of a positive ghost, it is particularly preferable that R^{B1} and R^{B2} each represent a hydrogen atom or an alkyl group having from 1 to 3 carbon atoms, and R^{B3} represents a hydrogen atom, an alkyl group having from 1 to 3 carbon atoms, or an alkoxy group having from 1 to 3 carbon atoms.

Hereinafter, specific examples of the specific benzophenone compound (compound represented by Formula (BP)) will be shown, but are not limited thereto.

| Example | | | |
|---|---|---|---|
| Compound No. | R^{B1} | R^{B2} | R^{B3} |
| BP-1 | H | H | 4-OH |
| BP-2 | H | H | 4-(CH₂)₇—CH₃ |
| BP-3 | H | H | 4-OCH₃ |
| BP-4 | H | H | H |
| BP-5 | H | 3-CH₃ | 4-OH |
| BP-6 | H | 3-CH₃ | 4-(CH₂)₇—CH₃ |
| BP-7 | H | 3-CH₃ | 4-OCH₃ |
| BP-8 | H | 3-CH₃ | H |
| BP-9 | H | 4-CH₃ | 4-OH |
| BP-10 | H | 4-CH₃ | 4-(CH₂)₇—CH₃ |
| BP-11 | H | 4-CH₃ | 4-OCH₃ |
| BP-12 | H | 4-CH₃ | H |
| BP-13 | 2-CH₃ | 4-CH₃ | 4-OH |
| BP-14 | 2-CH₃ | 4-CH₃ | 4-(CH₂)₇—CH₃ |
| BP-15 | 2-CH₃ | 4-CH₃ | 4-OCH₃ |
| BP-16 | 2-CH₃ | 4-CH₃ | H |
| BP-17 | H | 3-C₂H₅ | 4-OH |
| BP-18 | H | 3-C₂H₅ | 4-(CH₂)₇—CH₃ |
| BP-19 | H | 3-C₂H₅ | 4-OCH₃ |
| BP-20 | H | 3-C₂H₅ | H |
| BP-21 | H | 4-C₂H₅ | 4-OH |
| BP-22 | H | 4-C₂H₅ | 4-(CH₂)₇—CH₃ |
| BP-23 | H | 4-C₂H₅ | 4-OCH₃ |
| BP-24 | H | 4-C₂H₅ | H |

The mnemonic symbols in the example compounds have the following meanings. The number attached before the substituent is a substitution position for a benzene ring.

—CH₃: Methyl Group

—C₂H₅: Ethyl Group

—(CH₂)₇—CH₃: Octyl Group

—OCH₃: Methoxy Group

—OH: Hydroxy Group

The specific benzophenone compounds may be used alone or in combination of two or more kinds thereof.

The content of the specific benzophenone compound in the whole charge generation layer is preferably from 0.02% by weight to 20.0% by weight, and more preferably from 1.0% by weight to 12.0% by weight from the viewpoint of the prevention of a positive ghost and charge generation efficiency.

The content of the specific benzophenone compound with respect to 100 parts by weight of the phthalocyanine pigment is preferably from 1 part by weight to 20 parts by weight, and more preferably from 3 parts by weight to 10 parts by weight from the viewpoint of the prevention of a positive ghost.

### Binder Resin

The binder resin used in the charge generation layer is selected from wide ranges of insulating resins, and the binder resin may also be selected from organic photoconductive polymers such as poly-N-vinylcarbazole, polyvinyl anthracene, polyvinylpyrene, and polysilane.

Examples of the binder resin include polyvinylbutyral resins, polyarylate resins (such as polycondensates of bisphenols and aromatic divalent carboxylic acids), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, caseins, polyvinyl alcohol resins, and polyvinyl pyrrolidone resins. Here, the term “insulating” means that the volume resistivity is 10¹³ Ωcm or greater.

These binder resins are used alone or as a mixture of two or more kinds thereof.

The blending ratio between the charge generation material and the binder resin is preferably in a range from 10:1 to 1:10 in terms of the weight ratio.

Other well-known additives may be contained in the charge generation layer.

The formation of the charge generation layer is not particularly limited, and well-known forming methods are used. For example, the formation of the charge generation layer is performed by forming a coating film of a coating liquid for forming a charge generation layer, obtained by adding the components to a solvent, and drying the coating film, followed by heating, if necessary. The formation of the charge generation layer may be performed through deposition of the charge generation material. The formation of the charge generation layer by deposition is particularly suitable for a case of using a condensed aromatic pigment or a perylene pigment as the charge generation material.

Examples of the solvent for preparing the coating liquid for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or as a mixture of two or more kinds thereof.

For a method of dispersing particles (for example, charge generation material) in the coating liquid for forming a charge generation layer, for example, a media dispersing machine such as a ball mill, a vibration ball mill, an attritor, a sand mill, or a horizontal sand mill, or a medialess dispersing machine such as a stirrer, an ultrasonic dispersing machine, a roll mill, and a high-pressure homogenizer is used. Examples of the high-pressure homogenizer include a collision system in which the particles are dispersed by causing the dispersion to collide against liquid or against walls under high pressure, and a penetration system in which the particles are dispersed by causing the dispersion to penetrate through a fine flow path under high pressure.

The average particle diameter of the charge generation material in the coating liquid for forming a charge generation layer during the dispersion is effectively 0.5 μm or less, preferably 0.3 μm or less, and more preferably 0.15 μm or less.

Examples of the method of coating the undercoat layer (or intermediate layer) with the coating liquid for forming a charge generation layer include usual methods such as a blade coating method, a wire bar coating method, a spray coating method, a dipping coating method, a bead coating method, an air knife coating method, and a curtain coating method.

The thickness of the charge generation layer is set, for example, preferably in a range from 0.1 μm to 5.0 μm, and more preferably in a range from 0.2 μm to 2.0 μm.

### Charge Transport Layer

The charge transport layer is, for example, a layer containing a charge transport material and a binder resin. The charge transport layer may be a layer containing a polymeric charge transport material.

Examples of the charge transport material include electron transport compounds, such as quinone compounds such as p-benzoquinone, chloranil, bromanil, and anthraquinone; tetracyanoquinodimethane compounds; fluorenone compounds such as 2,4,7-trinitro fluorenone; xanthone compounds; benzophenone compounds; cyanovinyl compounds; and ethylene compounds. Other examples of the charge transport material include hole transport compounds such as triarylamine compounds, benzidine compounds, arylalkane compounds, aryl substituted ethylene compounds, stilbene compounds, anthracene compounds, and hydrazone compounds. These charge transport materials are used alone or in combination of two or more kinds thereof, but are not limited thereto.

The charge transport material preferably includes a butadiene charge transport material (CT1) and a benzidine charge transport material (CT2) from the viewpoint of the prevention of a positive ghost.

### Butadiene Charge Transport Material (CT1)

The butadiene charge transport material (CT1) will be described.

The butadiene charge transport material (CT1) is a charge transport material represented by the following Formula (CT1).

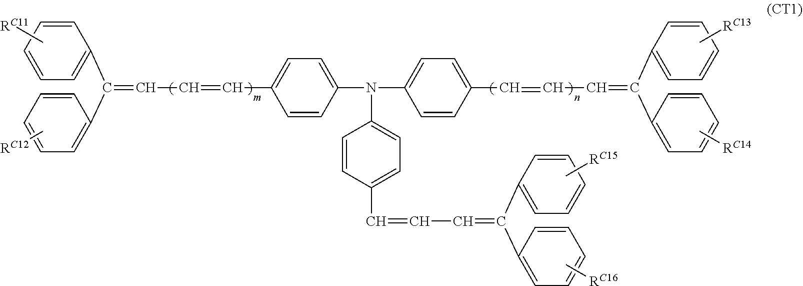

In Formula (CT1), R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, and two adjacent substituents may be bonded to each other to form a hydrocarbon ring structure.

n and m each independently represent 0, 1, or 2.

In Formula (CT1), as the halogen atom represented by R^{C11}, R^{C12}, R^{C13}, R^{C14}, R^{C15}, and R^{C16}, a fluorine atom, a chlorine atom, a bromine atom, an iodine atom, and the like are exemplified. Among these, a fluorine atom and a chlorine atom are preferred, and a chlorine atom is more preferred as the halogen atom.

In Formula (CT1), as the alkyl group represented by R^{C11}, R^{C12}, R^{C13}, R^{C14}, R^{C15}, and R^{C16}, a linear or branched alkyl group having from 1 to 20 carbon atoms (preferably from 1 to 6, and more preferably from 1 to 4) is exemplified.

Specific examples of the linear alkyl group include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, and an n-icosyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isoundecyl group, a sec-undecyl group, a tert-undecyl group, a neoundecyl group, an isododecyl group, a sec-dodecyl group, a tert-dodecyl group, a neododecyl group, an isotridecyl group, a sec-tridecyl group, a tert-tridecyl group, a neotridecyl group, an isotetradecyl group, a sec-tetradecyl group, a tert-tetradecyl group, a neotetradecyl group, a 1-isobutyl-4-ethyloctyl group, an isopentadecyl group, a sec-pentadecyl group, a tert-pentadecyl group, a neopentadecyl group, an isohexadecyl group, a sec-hexadecyl group, a tert-hexadecyl group, a neohexadecyl group, a 1-methylpentadecyl group, an isoheptadecyl group, a sec-heptadecyl group, a tert-heptadecyl group, a neoheptadecyl group, an isooctadecyl group, a sec-octadecyl group, a tert-octadecyl group, a neooctadecyl group, an isononadecyl group, a sec-nonadecyl group, a tert-nonadecyl group, a neononadecyl group, a 1-methyloctyl group, an isoicosyl group, a sec-isoicosyl group, a tert-icosyl group, and a neoicosyl group.

Among these, lower alkyl groups such as a methyl group, an ethyl group, and an isopropyl group are preferred as the alkyl group.

In Formula (CT1), as the alkoxy group represented by R^{C11}, R^{C12}, R^{C13}, R^{C14}, R^{C15}, and R^{C16}, a linear or branched alkoxy group having from 1 to 20 carbon atoms (preferably from 1 to 6, and more preferably from 1 to 4) is exemplified.

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, an n-hexadecyloxy group, an n-heptadecyloxy group, an n-octadecyloxy group, an n-nonadecyloxy group, and an n-icosyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, an isoundecyloxy group, a sec-undecyloxy group, a tert-undecyloxy group, a neoundecyloxy group, an isododecyloxy group, a sec-dodecyloxy group, a tert-dodecyloxy group, a neododecyloxy group, an isotridecyloxy group, a sec-tridecyloxy group, a tert-tridecyloxy group, a neotridecyloxy group, an isotetradecyloxy group, a sec-tetradecyloxy group, a tert-tetradecyloxy group, a neotetradecyloxy group, a 1-isobutyl-4-ethyloctyloxy group, an isopentadecyloxy group, a sec-pentadecyloxy group, a tert-pentadecyloxy group, a neopentadecyloxy group, an isohexadecyloxy group, a sec-hexadecyloxy group, a tert-hexadecyloxy group, a neohexadecyloxy group, a 1-methylpentadecyloxy group, an isoheptadecyloxy group, a sec-heptadecyloxy group, a tert-heptadecyloxy group, a neoheptadecyloxy group, an isooctadecyloxy group, a sec-octadecyloxy group, a tert-octadecyloxy group, a neooctadecyloxy group, an isononadecyloxy group, a sec-nonadecyloxy group, a tert-nonadecyloxy group, a neononadecyloxy group, a 1-methyloctyloxy group, an isoicosyloxy group, a sec-icosyloxy group, a tert-icosyloxy group, and a neoicosyloxy group.

Among these, a methoxy group is preferred as the alkoxy group.

In Formula (CT1), as the aryl group represented by R^{C11}, R^{C12}, R^{C13}, R^{C14}, R^{C15}, and R^{C16}, an aryl group having from 6 to 30 carbon atoms (preferably from 6 to 20, and more preferably from 6 to 16) is exemplified.

Specific examples of the aryl group include a phenyl group, a naphthyl group, a phenanthryl group, and a biphenyl group.

Among these, a phenyl group and a naphthyl group are preferred as the aryl group.

In Formula (CT1), the substituents represented by R^{C11}, R^{C12}, R^{C13}, R^{C14}, R^{C15}, and R^{C16} also include a group further having a substituent. Examples of this substituent include the atoms and groups exemplified in the above description (such as a halogen atom, an alkyl group, an alkoxy group, and an aryl group).

In Formula (CT1), in a hydrocarbon ring structure in which two adjacent substituents of R^{C11}, R^{C12}, R^{C13}, R^{C14}, R^{C15}, and R^{C16} (for example, R^{C11} and R^{C12}, R^{C13} and R^{C14}, and R^{C15} and R^{C16}) are connected to each other, a single bond, a 2,2′-methylene group, a 2,2′-ethylene group, a 2,2′-vinylene group, and the like are exemplified as a group connecting the substituents to each other. Among these, a single bond and a 2,2′-methylene group are preferred.

Here, specific examples of the hydrocarbon ring structure include a cycloalkane structure, a cycloalkane structure, and a cycloalkane polyene structure.

In Formula (CT1), each of n and m is preferably 1.

In Formula (CT1), from the viewpoint of the formation of a photosensitive layer (charge transport layer) having high charge transport ability, it is preferable that R^{C11}, R^{C12}, R^{C13}, R^{C14}, R^{C15}, and R^{C16} each independently represent a hydrogen atom, an alkyl group having from 1 to 20 carbon atoms, or an alkoxy group having from 1 to 20 carbon atoms, and each of m and n represents 1 or 2, and it is more preferable that R^{C11}, R^{C12}, R^{C13}, R^{C14}, R^{C15}, and R^{C16} represent a hydrogen atom, and each of m and n represents 1.

That is, the butadiene charge transport material (CT1) is more preferably a charge transport material (example compound (CT1-3)) represented by the following Formula (CT1A).

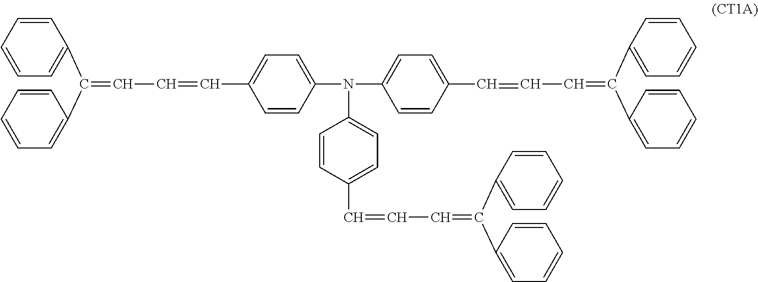 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

Hereinafter, specific examples of the butadiene charge transport material (CT1) will be shown, but are not limited thereto.

| Example | | | | | | | | |
|---|---|---|---|---|---|---|---|---|
| Compound | | | | | | | | |
| No. | m | n | R^{C11} | R^{C12} | R^{C13} | R^{C14} | R^{C15} | R^{C16} |
| CT1-1 | 1 | 1 | 4-CH₃ | 4-CH₃ | 4-CH₃ | 4-CH₃ | H | H |
| CT1-2 | 2 | 2 | H | H | H | H | 4-CH₃ | 4-CH₃ |
| CT1-3 | 1 | 1 | H | H | H | H | H | H |
| CT1-4 | 2 | 2 | H | H | H | H | H | H |
| CT1-5 | 1 | 1 | 4-CH₃ | 4-CH₃ | 4-CH₃ | H | H | H |
| CT1-6 | 0 | 1 | H | H | H | H | H | H |
| CT1-7 | 0 | 1 | 4-CH₃ | 4-CH₃ | 4-CH₃ | 4-CH₃ | 4-CH₃ | 4-CH₃ |
| CT1-8 | 0 | 1 | 4-CH₃ | 4-CH₃ | H | H | 4-CH₃ | 4-CH₃ |
| CT1-9 | 0 | 1 | H | H | 4-CH₃ | 4-CH₃ | H | H |
| CT1-10 | 0 | 1 | H | H | 3-CH₃ | 3-CH₃ | H | H |
| CT1-11 | 0 | 1 | 4-CH₃ | H | H | H | 4-CH₃ | H |
| CT1-12 | 0 | 1 | 4-OCH₃ | H | H | H | 4-OCH₃ | H |
| CT1-13 | 0 | 1 | H | H | 4-OCH₃ | 4-OCH₃ | H | H |
| CT1-14 | 0 | 1 | 4-OCH₃ | H | 4-OCH₃ | H | 4-OCH₃ | 4-OCH₃ |
| CT1-15 | 0 | 1 | 3-CH₃ | H | 3-CH₃ | H | 3-CH₃ | H |
| CT1-16 | 1 | 1 | 4-CH₃ | 4-CH₃ | 4-CH₃ | 4-CH₃ | 4-CH₃ | 4-CH₃ |
| CT1-17 | 1 | 1 | 4-CH₃ | 4-CH₃ | H | H | 4-CH₃ | 4-CH₃ |
| CT1-18 | 1 | 1 | H | H | 4-CH₃ | 4-CH₃ | H | H |
| CT1-19 | 1 | 1 | H | H | 3-CH₃ | 3-CH₃ | H | H |
| CT1-20 | 1 | 1 | 4-CH₃ | H | H | H | 4-CH₃ | H |
| CT1-21 | 1 | 1 | 4-OCH₃ | H | H | H | 4-OCH₃ | H |
| CT1-22 | 1 | 1 | H | H | 4-OCH₃ | 4-OCH₃ | H | H |
| CT1-23 | 1 | 1 | 4-OCH₃ | H | 4-OCH₃ | H | 4-OCH₃ | 4-OCH₃ |
| CT1-24 | 1 | 1 | 3-CH₃ | H | 3-CH₃ | H | 3-CH₃ | H |

The mnemonic symbols in the example compounds have the following meanings. The number attached before the substituent is a substitution position for a benzene ring.

—CH₃: Methyl Group

—OCH₃: Methoxy Group

The butadiene charge transport materials (CT1) may be used alone or in combination of two or more kinds thereof.

### Benzidine Charge Transport Material (CT2)

The benzidine charge transport material (CT2) will be described.

The benzidine charge transport material (CT2) is a charge transport material represented by the following Formula (CT2).

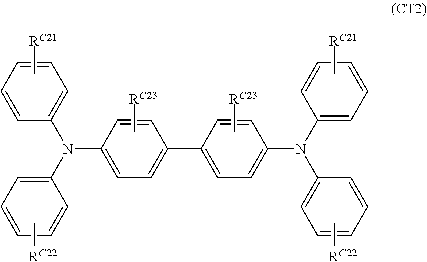

In Formula (CT2), R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

In Formula (CT2), as the halogen atom represented by R^{C21}, R^{C22}, and R^{C23}, a fluorine atom, a chlorine atom, a bromine atom, an iodine atom, and the like are exemplified. Among these, a fluorine atom and a chlorine atom are preferred, and a chlorine atom is more preferred as the halogen atom.

In Formula (CT2), as the alkyl group represented by R^{c21}, R^{C22}, and R^{C23}, a linear or branched alkyl group having from 1 to 10 carbon atoms (preferably from 1 to 6, and more preferably from 1 to 4) is exemplified.

Specific examples of the linear alkyl group include a methyl group, an ethyl group, an n-propyl group, an n-butyl group, an n-pentyl group, an n-hexyl group, an n-heptyl group, an n-octyl group, an n-nonyl group, and an n-decyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Among these, lower alkyl groups such as a methyl group, an ethyl group, and an isopropyl group are preferred as the alkyl group.

In Formula (CT2), as the alkoxy group represented by R^{C21}, R^{C22}, and R^{C23}, a linear or branched alkoxy group having from 1 to 10 carbon atoms (preferably from 1 to 6, and more preferably from 1 to 4) is exemplified.

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Among these, a methoxy group is preferred as the alkoxy group.

In Formula (CT2), as the aryl group represented by R^{C21}, R^{C22}, and R^{C23}, an aryl group having from 6 to 10 carbon atoms (preferably from 6 to 9, and more preferably from 6 to 8) is exemplified.

Specific examples of the aryl group include a phenyl group and a naphthyl group.

Among these, a phenyl group is preferred as the aryl group.

In Formula (CT2), the substituents represented by R^{C21}, R^{C22}, and R^{C23} also include a group further having a substituent. Examples of this substituent include the atoms and groups exemplified in the above description (such as a halogen atom, an alkyl group, an alkoxy group, and an aryl group).

In Formula (CT2), particularly, from the viewpoint of the formation of a photosensitive layer (charge transport layer) having high charge transport ability, it is preferable that R^{C21}, R^{C22}, and R^{C23} each independently represent a hydrogen atom or an alkyl group having from 1 to 10 carbon atoms, and it is more preferable that R^{C21} and R^{C23} represent a hydrogen atom, and R^{C22} represents an alkyl group having from 1 to 10 carbon atoms (particularly, methyl group).

Specifically, the benzidine charge transport material (CT2) is particularly preferably a charge transport material (example compound (CT2-2)) represented by the following Formula (CT2A).

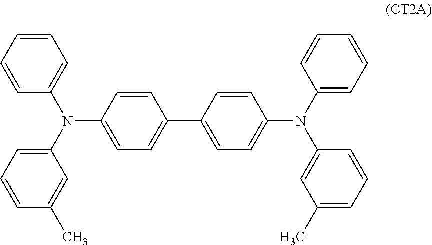 [SMILES: Cc1cccc(N(c2ccccc2)c2ccc(-c3ccc(N(c4ccccc4)c4cccc(C)c4)cc3)cc2)c1]

Hereinafter, specific examples of the benzidine charge transport material (CT2) will be shown, but are not limited thereto.

| Example | | | |
|---|---|---|---|
| Compound No. | R^{C21} | R^{C22} | R^{C23} |
| CT2-1 | H | H | H |
| CT2-2 | H | 3-CH₃ | H |
| CT2-3 | H | 4-CH₃ | H |
| CT2-4 | H | 3-C₂H₅ | H |
| CT2-5 | H | 4-C₂H₅ | H |
| CT2-6 | H | 3-OCH₃ | H |
| CT2-7 | H | 4-OCH₃ | H |
| CT2-8 | H | 3-OC₂H₅ | H |
| CT2-9 | H | 4-OC₂H₅ | H |
| CT2-10 | 3-CH₃ | 3-CH₃ | H |
| CT2-11 | 4-CH₃ | 4-CH₃ | H |
| CT2-12 | 3-C₂H₅ | 3-C₂H₅ | H |
| CT2-13 | 4-C₂H₅ | 4-C₂H₅ | H |
| CT2-14 | H | H | 2-CH₃ |
| CT2-15 | H | H | 3-CH₃ |
| CT2-16 | H | 3-CH₃ | 2-CH₃ |
| CT2-17 | H | 3-CH₃ | 3-CH₃ |
| CT2-18 | H | 4-CH₃ | 2-CH₃ |
| CT2-19 | H | 4-CH₃ | 3-CH₃ |
| CT2-20 | 3-CH₃ | 3-CH₃ | 2-CH₃ |
| CT2-21 | 3-CH₃ | 3-CH₃ | 3-CH₃ |
| CT2-22 | 4-CH₃ | 4-CH₃ | 2-CH₃ |
| CT2-23 | 4-CH₃ | 4-CH₃ | 3-CH₃ |

The mnemonic symbols in the example compounds have the following meanings. The number attached before the substituent is a substitution position for a benzene ring.

—CH₃: Methyl Group

—C₂H₅: Ethyl Group

—OCH₃: Methoxy Group

—OC₂H₅: Ethoxy Group

The benzidine charge transport materials (CT2) may be used alone or in combination of two or more kinds thereof.

Next, the content of the charge transport material will be described.

The content of the butadiene charge transport material (CT1) is preferably in a range from 0.1:9.9 to 4.0:6.0, more preferably from 0.4:9.6 to 3.5:6.5, and even more preferably from 0.6:9.4 to 3.0:7.0 in terms of the blending ratio (weight ratio, CT1: binder resin) between CT1 and the binder resin from the viewpoint of the formation of a photosensitive layer (charge transport layer) having high charge transport ability.

The content of the benzidine charge transport materials (CT2) is preferably in a range from 1:9 to 7:3, more preferably from 2:8 to 6:4, and even more preferably from 2:8 to 4:6 in terms of the blending ratio (weight ratio, CT2: binder resin) between CT2 and the binder resin from the viewpoint of the formation of a photosensitive layer (charge transport layer) having high charge transport ability.

The weight ratio (the content of the butadiene charge transport material (CT1)/the content of the benzidine charge transport materials (CT2)) of the content of the butadiene charge transport material (CT1) to the content of the benzidine charge transport materials (CT2) is preferably from 1/9 to 5/5, more preferably from 1/9 to 4/6, and even more preferably from 1/9 to 3/7 from the viewpoint of the formation of a photosensitive layer (charge transport layer) having high charge transport ability.

In addition to the butadiene charge transport material (CT1) and the benzidine charge transport materials (CT2), other charge transport materials may be used in combination. In that case, the content of other charge transport materials in all of the charge transport materials may be 10% by weight or less (preferably 5% by weight or less).

Examples of the binder resin used in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinyl carbazole, and polysilane. Among these, polycarbonate resins or polyarylate resins are suitable as the binder resin. These binder resins are used alone or in combination of two or more kinds thereof.

The blending ratio between the charge transport material and the binder resin is preferably from 10:1 to 1:5 in terms of the weight ratio.

The charge transport layer may contain components other than the charge transport material and the binder resin. Examples of other components include well-known additives in addition to the above-described specific benzophenone compound.

The formation of the charge transport layer is not particularly limited, and well-known forming methods are used. For example, the formation of the charge transport layer is performed by forming a coating film of a coating liquid for forming a charge transport layer, obtained by adding the components to a solvent, and drying the coating film, followed by heating, if necessary.

Examples of the solvent for preparing the coating liquid for forming a charge transport layer include aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents may be used alone or as a mixture of two or more kinds thereof.

Examples of the coating method for a case of coating the charge generation layer with the coating liquid for forming a charge transport layer include usual methods such as a blade coating method, a wire bar coating method, a spray coating method, a dipping coating method, a bead coating method, an air knife coating method, and a curtain coating method.

The thickness of the charge transport layer is set in a range, for example, preferably from 5 μm to 50 μm, and more preferably from 10 μm to 30 μm.

### Protective Layer

A protective layer is provided on the photosensitive layer if necessary. The protective layer is provided in order to, for example, prevent chemical changes of the photosensitive layer during charging, or to further improve mechanical strength of the photosensitive layer.

Therefore, as the protective layer, a layer composed of a cured film (crosslinking film) may be applied. As these layers, for example, a layer described by the following description 1) or 2) is exemplified.

1) Layer composed of a cured film of a composition containing a reactive group-containing charge transport material in which a reactive group and a charge transport skeleton are contained in the same molecule (that is, a layer containing a polymer of the reactive group-containing charge transport material, or a crosslinking substance)

2) Layer composed of a cured film of a composition containing a non-reactive charge transport material and a reactive group-containing no-charge transport material that has no charge transport skeleton, but has a reactive group (that is, a layer containing the non-reactive charge transport material, and a polymer or crosslinked product of the reactive group-containing no-charge transport material)

Examples of the reactive group of the reactive group-containing charge transport material include well-known reactive groups such as a chain polymerizable group, an epoxy group, —OH, —OR (where, R represents an alkyl group), —NH₂, —SH, —COOH, —SiR^{Q1}_{3-Qn}(OR^{Q2})_{Qn} (where, R^{Q1} represents a hydrogen atom, an alkyl group, or a substituted or unsubstituted aryl group, and R^{Q2} represents a hydrogen atom, an alkyl group, or a trialkylsilyl group. Qn represents an integer of from 1 to 3).

The chain polymerizable group is not particularly limited as long as it is a functional group enabling radical polymerization. For example, the chain polymerizable group is a functional group having a group containing at least a carbon double bond. Specific examples thereof include a group containing at least one selected from a vinyl group, a vinyl ether group, a vinyl thioether group, a styryl group, a vinylphenyl group, an acryloyl group, a methacryloyl group, and derivatives thereof. Among these, a group containing at least one selected from a vinyl group, a vinylphenyl group, an acryloyl group, a methacryloyl group, and derivatives thereof is preferred as the chain polymerizable group due to excellent reactivity.

The charge transport skeleton of the reactive group-containing charge transport material is not particularly limited as long as it is a known structure in the electrophotographic photoreceptor. For example, the charge transport skeleton may be a skeleton derived from a nitrogen-containing hole transport compound such as a triarylamine compound, a benzidine compound, and a hydrazone compound, and include a structure conjugated with a nitrogen atom. Among these, a triarylamine skeleton is preferred.

The reactive group-containing charge transport material having the reactive group and the charge transport skeleton, the non-reactive charge transport material, and the reactive group-containing no-charge transport material may be selected from known materials.

The protective layer may contain well-known other additives.

The formation of the protective layer is not particularly limited, and well-known forming methods are used. For example, the formation of the protective layer is performed by forming a coating film of a coating liquid for forming a protective layer, obtained by adding the components to a solvent, and drying the coating film, followed by heating, if necessary.

Examples of the solvent for preparing the coating liquid for forming a protective layer include aromatic solvents such as toluene and xylene; ketone solvents such as methyl ethyl ketone, methyl isobutyl ketone, and cyclohexanone; ester solvents such as ethyl acetate and butyl acetate; ether solvents such as tetrahydrofuran and dioxane; cellosolve solvents such as ethylene glycol monomethyl ether; and alcohol solvents such as isopropyl alcohol and butanol. These solvents are used alone or as a mixture of two or more kinds thereof.

The coating liquid for forming a protective layer may be a coating liquid having no solvent.

Examples of the method of coating the photosensitive layer (for example, charge transport layer) with the coating liquid for forming a protective layer include usual methods such as a dipping coating method, an extrusion coating method, a wire bar coating method, a spray coating method, a blade coating method, a knife coating method, and a curtain coating method.

The thickness of the protective layer is set in a range, for example, preferably from 1 μm to 20 μm, and more preferably from 2 μm to 10 μm.

Image Forming Apparatus (and Process Cartridge)

An image forming apparatus according to this exemplary embodiment is provided with an electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor by a developer including a toner to forma toner image, and a transfer device that transfers the toner image onto a surface of a recording medium. Further, as the electrophotographic photoreceptor, the electrophotographic photoreceptor according to the exemplary embodiment is applied.

As the image forming apparatus according to this exemplary embodiment, well-known image forming apparatuses such as apparatuses provided with a fixing device that fixes a toner image transferred onto a surface of a recording medium; direct transfer-type apparatuses that directly transfer a toner image formed on a surface of an electrophotographic photoreceptor onto a recording medium; intermediate transfer-type apparatuses that primarily transfer a toner image formed on a surface of an electrophotographic photoreceptor onto a surface of an intermediate transfer member, and secondarily transfer the toner image transferred onto the surface of the intermediate transfer member onto a surface of a recording medium; apparatuses provided with a cleaning device that cleans a surface of an electrophotographic photoreceptor before charging, after transfer of a toner image; apparatuses provided with an erasing device that erases charges by irradiating a surface of an image holing member before charging with erasing light, after transfer of a toner image; and apparatuses provided with an electrophotographic photoreceptor heating member that increases the temperature of an electrophotographic photoreceptor to reduce the relative temperature are applied.

In the case of an intermediate transfer-type apparatus, for the transfer device, for example, a configuration in which an intermediate transfer member in which a toner image is transferred onto a surface, a primary transfer device that primarily transfers the toner image formed on the surface of an image holding member onto the surface of the intermediate transfer member, and a secondary transfer device that secondarily transfers the toner image transferred onto the surface of the intermediate transfer member onto a surface of a recording medium is applied.

The image forming apparatus according to this exemplary embodiment may be any one of a dry developing-type image forming apparatus and a wet developing-type (developing type using a liquid developer) image forming apparatus.

The image forming apparatus according to this exemplary embodiment may have, for example, a cartridge structure (process cartridge) in which a part provided with the electrophotographic photoreceptor may be detachably attached to the image forming apparatus. As the process cartridge, for example, a process cartridge provided with the electrophotographic photoreceptor according to this exemplary embodiment is suitably used. Further, the process cartridge may be provided with, in addition to the electrophotographic photoreceptor, for example, at least one selected from the group consisting of a charging device, an electrostatic latent image forming device, a developing device, and a transfer device.

Hereinafter, an example of the image forming apparatuses according to this exemplary embodiment will be shown, but the invention is not limited thereto. Major parts illustrated in the drawings will be described, and description of the others will be omitted.

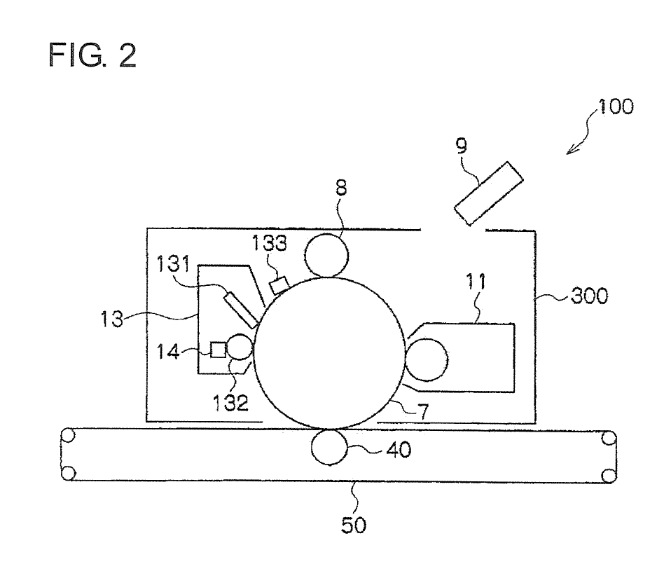

FIG. 2 is a schematic configuration diagram illustrating an example of the image forming apparatus according to this exemplary embodiment.

An image forming apparatus 100 according to this exemplary embodiment is provided with a process cartridge 300 provided with an electrophotographic photoreceptor 7, an exposure device 9 (an example of the electrostatic latent image forming device), a transfer device 40 (primary transfer device), and an intermediate transfer member 50 as illustrated in FIG. 2. In the image forming apparatus 100, the exposure device 9 is positioned so as to apply light to the electrophotographic photoreceptor 7 from an opening of the process cartridge 300, the transfer device 40 is positioned so as to be opposed to the electrophotographic photoreceptor 7 via the intermediate transfer member 50, and the intermediate transfer member 50 is disposed to be partially in contact with the electrophotographic photoreceptor 7. Although not shown in the drawings, the image forming apparatus also has a secondary transfer device that transfers a toner image transferred onto the intermediate transfer member 50 onto a recording medium (for example, paper). The intermediate transfer member 50, the transfer device 40 (primary transfer device), and the secondary transfer device (not shown) correspond to an example of the transfer device.

The process cartridge 300 in FIG. 2 supports, in a housing, the electrophotographic photoreceptor 7, a charging device 8 (an example of the charging device), a developing device 11 (an example of the developing device), and a cleaning device 13 (an example of the cleaning device) integrally. The cleaning device 13 has a cleaning blade 131 (an example of the cleaning member), and the cleaning blade 131 is disposed so as to be in contact with the surface of the electrophotographic photoreceptor 7. The cleaning member is not an embodiment of the cleaning blade 131, may be a conductive or insulating fibrous member, and may be used alone or in combination with the cleaning blade 131.

FIG. 2 illustrates an example in which the image forming apparatus includes a fibrous member 132 (roll shape) that supplies a lubricant 14 to the surface of the electrophotographic photoreceptor 7 and a fibrous member 133 (flat brush shape) that assists in cleaning, but these members are disposed if necessary.

Hereinafter, the respective configurations of the image forming apparatus according to this exemplary embodiment will be described.

### Charging Device

As the charging device 8, for example, a contact-type charging unit using a conductive or semiconductive charging roller, charging brush, charging film, charging rubber blade, charging tube, or the like is used. In addition, a known charging unit such as a non-contact-type roller charging unit, or a scorotron charging unit or a corotron charging unit using corona discharge, is also used.

### Exposure Device

Examples of the exposure device 9 include optical instruments that expose the surface of the electrophotographic photoreceptor 7 to light such as semiconductor laser light, LED light, or liquid crystal shutter light according to a prescribed image. The wavelength of the light source may be in the spectral sensitivity region of the electrophotographic photoreceptor. As the wavelength of the semiconductor laser, near infrared wavelengths that are oscillation wavelengths near 780 nm are predominant. However, the wavelength of the semiconductor laser is not limited to such wavelengths, and a laser having an oscillation wavelength of 600 nm range or a laser having an oscillation wavelength in a range from 400 nm to 450 nm as a blue laser may also be used. In order to forma color image, it is also effective to use a planar light emission-type laser light source capable of outputting multi-beams.

### Developing Device

Examples of the developing device 11 include common developing devices in which a developer is used in either contact or non-contact manner for developing. The developing device 11 is not particularly limited as long as it has the above-described functions, and is selected according to the intended use. Examples thereof include known developing units having a function of adhering a single-component or two-component developer to the electrophotographic photoreceptor 7 using a brush or a roller. Among these, a developing unit using a developing roller retaining a developer on a surface thereof is preferred.

The developer used in the developing device 11 may be a single-component developer formed of a toner alone or a two-component developer formed of a toner and a carrier. The developer may be magnetic or non-magnetic. As the developer, known developers are applied.

### Cleaning Device

As the cleaning device 13, a cleaning blade-type device provided with the cleaning blade 131 is used.

Other than the cleaning blade type, a fur brush cleaning type or a type of performing developing and cleaning at once may also be employed.

### Transfer Device

Examples of the transfer device 40 include known transfer charging units such as a contact-type transfer charging unit using a belt, a roller, a film, a rubber blade, or the like, and a scorotron transfer charging unit or a corotron transfer charging unit using corona discharge.

### Intermediate Transfer Member

As the intermediate transfer member 50, a belt-like material (intermediate transfer belt) containing polyimide, polyamideimide, polycarbonate, polyarylate, polyester, rubber, or the like, to which semiconductive properties are imparted, is used. In addition, the intermediate transfer member may have a drum form other than the belt form as the form of the intermediate transfer member.

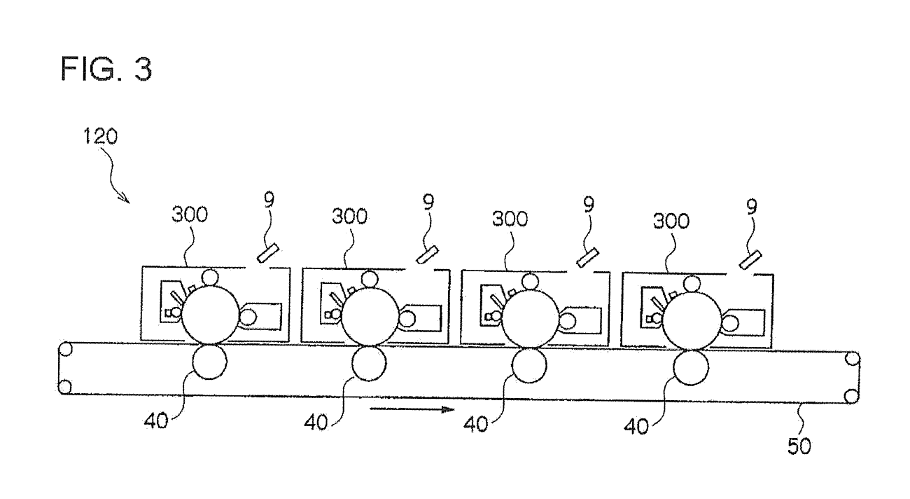

FIG. 3 is a schematic configuration diagram illustrating another example of the image forming apparatus according to this exemplary embodiment.

An image forming apparatus 120 shown in FIG. 3 is a tandem multi-color image forming apparatus equipped with four process cartridges 300. The image forming apparatus 120 has a configuration in which four process cartridges 300 are arranged in parallel on an intermediate transfer member 50 and one electrophotographic photoreceptor is used for one color. The image forming apparatus 120 has the same configuration as the image forming apparatus 100, except that it is a tandem type.

### EXAMPLES

Hereinafter, examples of the invention will be described, but the invention is not limited to the following examples.

### Example 1

100 parts by weight of a zinc oxide (trade name: MZ 300, manufactured by Tayca Corporation), 10 parts by weight of a toluene solution of 10% by weight of N-2-(aminoethyl)-3-aminopropyltriethoxysilane as a silane coupling agent, and 200 parts by weight of toluene are mixed to be stirred, and reflux is performed for 2 hours. Then, the toluene is distilled away under reduced pressure of 10 mmHg, and baking is performed for 2 hours at 135° C. to subject the zinc oxide to a surface treatment with the silane coupling agent.

33 parts by weight of the surface-treated zinc oxide, 6 parts by weight of blocked isocyanate (trade name: SUMIDUR 3175, manufactured by Sumitomo-Bayer Urethane Co., Ltd.), 1 part by weight of a compound represented by the following Formula (AK-1), and 25 parts by weight of methyl ethyl ketone are mixed for 30 minutes, and then 5 parts by weight of a butyral resin (trade name: S-LEC BM-1, manufactured by Sekisui Chemical Co., Ltd.), 3 parts by weight of silicone balls (trade name: TOSPEARL 120, manufactured by Momentive Performance Materials Inc.), and 0.01 parts by weight of a silicone oil (trade name: SH29PA, manufactured by Dow Corning Corporation) as a leveling agent are added thereto. The mixture is dispersed using a sand mill for 3 hours, and thus a coating liquid for forming an undercoat layer is obtained.

An aluminum base having a diameter of 47 mm, a length of 357 mm, and a thickness of 1 mm is coated with the coating liquid for forming an undercoat layer through a dipping coating method, and the coating liquid is dried at 180° C. for 30 minutes to be cured. Thus, an undercoat layer having a thickness of 25 μm is obtained.

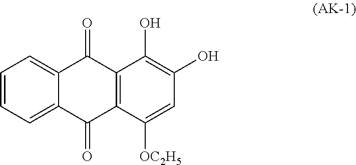 [SMILES: CCOc1cc(O)c(O)c2c1C(=O)c1ccccc1C2=O]

Next, a mixture including a phthalocyanine pigment as a charge generation material shown in Table 1, an additive (specific benzophenone compound) shown in Table 1, a vinyl chloride-vinyl acetate copolymer resin (trade name: VMCH, manufactured by NUC Corporation) as a binder resin, and n-butyl acetate as a catalyst is put into a glass bottle having a capacity of 100 mL together with 1.0 mmφ glass beads at a filling rate of 50%, and is dispersed for 2.5 hours using a paint shaker to obtain a coating liquid for a charge generation layer.

The content (% by weight) of the phthalocyanine pigment and the content (% by weight) of the additive with respect to the total content (that is, solid content) of the phthalocyanine pigment, the additive, and the binder resin are shown in Table 1.

The content of the solid content with respect to the whole coating liquid for a charge generation layer is 6.0% by weight.

The undercoat layer is dipped in and coated with the obtained coating liquid for forming a charge generation layer, and dried for 5 minutes at 100° C., and thus a charge generation layer having a thickness of 0.20 μm is formed.

Next, a charge transport material 1 as a charge transport material of which the kind and amount (parts by weight) to be added are shown in Table 1, a charge transport material 2 as a charge transport material of which the kind and amount (parts by weight) to be added are shown in Table 1, and 60.0 parts by weight of a bisphenol Z polycarbonate resin (homopolymerization-type polycarbonate resin of bisphenol Z, viscosity-average molecular weight: 40,000) as a binder resin are added to and dissolved in 340.0 parts by weight of tetrahydrofuran as a solvent, and thus a coating liquid for forming a charge transport layer is obtained.

The charge generation layer is dipped in and coated with the obtained coating liquid for forming a charge transport layer, and dried for 40 minutes at 150° C., and thus a charge transport layer having a thickness of 34 μm is formed.

An electrophotographic photoreceptor is obtained through the above processes.

### Examples 2 to 11 and Comparative Examples 1 to 3

Electrophotographic photoreceptors are produced in the same manner as in Example 1, except that the kind and the content of the phthalocyanine pigment, the kind and the content of the additive, the kind and the amount of the charge transport material 1, and the kind and the content of the charge transport material 2 are changed in accordance with Table 1.

### Evaluation

Regarding the electrophotographic photoreceptors obtained in the examples, evaluation of “positive ghost”, “burning ghost”, and “optical fatigue” is made. The results thereof are shown in Table 1.

### Evaluation of Image Density and Positive Ghost

The electrophotographic photoreceptor obtained in each example is mounted on an electrophotographic image forming apparatus (manufactured by Fuji Xerox Co., Ltd.: Versant 2100 Press), a 100% black 1-cm square image is output in a region (147 mm from an edge of the paper) corresponding to first cycle in A3 paper, and then an entire surface half-tone image (cyan entire surface half-tone image) having an image density of 20% is output in a region corresponding to second cycle below a position 147 mm from an edge of paper.

The output 100% black image is observed, and visual sensory evaluation (good or poor) is performed regarding the image density. Specifically, a case in which a target image density is output is determined as “good”, and a case in which a density lower than the target image density is visually recognized is determined as “poor”.

The output entire surface half-tone image is observed, and visual sensory evaluation (grade determination) is performed regarding the difference in density (positive ghost) between the 1-cm square and the surroundings thereof. The grade is determined from G0 to G6 on 1 G basis. The smaller the number of G, the smaller the difference in density, and the less the positive ghost occurs. The acceptable grades of the positive ghost are G4 or lower, and G3.5 or lower is preferred.

The printing is performed under an environment of 28° C. and 85% RH.

### Evaluation of Burning Ghost

The electrophotographic photoreceptor obtained in each example is mounted on an electrophotographic image forming apparatus (manufactured by Fuji Xerox Co., Ltd.: Versant 2100 Press), a lattice pattern chart is continuously output on 3,000 sheets of A3 paper, and then an entire surface half-tone image (cyan entire surface half-tone image) having an image density of 20% is output on a sheet of A3 paper.

The output entire surface half-tone image is observed, and visual sensory evaluation (grade determination) is performed regarding the difference in density between the continuous printing part of the lattice pattern and the non-continuous printing part. The grade is determined from G0 to G6 on 1 G basis. The smaller the number of G, the smaller the difference in density, and the less the burning ghost occurs. The acceptable grades of the burning ghost are G4 or lower, and G3.5 or lower is preferred.

The printing is performed under an environment of 28° C. and 85% RH.

### Evaluation of Optical Fatigue

First, the electrophotographic photoreceptor obtained in each example is wrapped in black paper with a 2-cm square window, and left for 10 minutes under a white fluorescent lamp (1,000 Lux) to expose the electrophotographic photoreceptor to light such that only an open window part is exposed to the light.

Next, the electrophotographic photoreceptor exposed to the light is mounted on an electrophotographic image forming apparatus (manufactured by Fuji Xerox Co., Ltd.: Versant 2100 Press), and an entire surface half-tone image (cyan) having an image density of 50% is output on a sheet of A3 paper.

The output entire surface half-tone image is observed, and visual sensory evaluation (grade determination) is performed regarding the difference in density between the light-exposed part and the non-light-exposed part. The grade is determined from G0 to G6 on 0.5 G basis. The smaller the number of G, the smaller the difference in density, and the less the optical fatigue occurs. The acceptable grades of the optical fatigue are G4 or lower, and G3.5 or lower is preferred.

The printing is performed under an environment of 28° C. and 85% RH.

The examples, the comparative examples, and the evaluation results thereof are shown as a list in Table 1.

In Table 1, the symbol “-” indicates that the corresponding material is not used.

TABLE 1

| | | | | | Charge Transport Layer | | | | | | | |
|---|---|---|---|---|---|---|---|---|---|---|---|---|
| | | | | | Charge | | Charge | | | | | |
| | Charge Generation Layer | | | | Transport | | Transport | | | | | |
| | Phthalocyanine | | | | Material 1 | | Material 2 | | | | | |
| | Pigment | | Additive | | | Amount to | | Amount to | | | | |
| | | Content | | Content | | be Added | | be Added | Evaluation | | | |
| | | (% by | | (% by | | (parts by | | (parts by | Image | Positive | Burning | Optical |
| | Kind | weight) | Kind | weight) | Kind | weight) | Kind | weight) | Density | Ghost | Ghost | Fatigue |
| Example 1 | PC-1 | 60 | BP-4 | 3 | Formula | 67 | — | — | Good | G3 | G3 | G3 |
| | | | | | (4) | | | | | | | |
| Example 2 | PC-1 | 60 | BP-4 | 3 | CT1-1 | 67 | — | — | Good | G2 | G2 | G2 |
| Example 3 | PC-1 | 60 | BP-4 | 3 | CT1-1 | 8.0 | CT2-2 | 32.0 | Good | G0 | G0 | G0 |
| Example 4 | PC-1 | 60 | BP-4 | 1.2 | CT1-1 | 8.0 | CT2-2 | 32.0 | Good | G3 | G3 | G3 |
| Example 5 | PC-1 | 60 | BP-4 | 12 | CT1-1 | 8.0 | CT2-2 | 32.0 | Good | G2 | G2 | G2 |
| Example 6 | PC-1 | 60 | BP-8 | 3 | CT1-1 | 8.0 | CT2-2 | 32.0 | Good | G0 | G0 | G0 |
| Example 7 | PC-1 | 60 | BP-4 | 3 | CT1-2 | 8.0 | CT2-2 | 32.0 | Good | G0 | G0 | G0 |
| Example 8 | PC-1 | 60 | BP-4 | 3 | CT1-1 | 8.0 | CT2-1 | 32.0 | Good | G0 | G0 | G0 |
| Example 9 | PC-1 | 60 | BP-4 | 0.6 | CT1-1 | 8.0 | CT2-2 | 32.0 | Good | G4 | G4 | G4 |
| Example 10 | PC-1 | 60 | BP-4 | 18 | CT1-1 | 8.0 | CT2-2 | 32.0 | Poor | G4 | G4 | G4 |
| Example 11 | PC-2 | 60 | BP-4 | 3 | CT1-1 | 8.0 | CT2-2 | 32.0 | Good | G3 | G3.5 | G3.5 |
| Comparative | PC-1 | 60 | — | — | CT1-1 | 8.0 | CT2-2 | 32.0 | Good | G6 | G6 | G6 |
| Example 1 | | | | | | | | | | | | |
| Comparative | PC-1 | 60 | Formula | 3 | CT1-1 | 8.0 | CT2-2 | 32.0 | Good | G5 | G5 | G5 |
| Example 2 | | | (5) | | | | | | | | | |
| Comparative | PC-1 | 60 | Formula | 3 | CT1-1 | 8.0 | CT2-2 | 32.0 | Good | G5 | G5 | G5 |
| Example 3 | | | (6) | | | | | | | | | |

From the above results, it is found that in the examples, the “positive ghost”, “burning ghost”, and “optical fatigue” are prevented in comparison to the comparative examples.

In addition, it is found that in Examples 1 to 8 and Example 11 in which the content of the specific benzophenone compound is appropriate, the “positive ghost” is more prevented than in Examples 9 and 10.

Details of Table 1 such as abbreviations are as follows.

PC-1: Hydroxygallium Phthalocyanine Pigment “V-type hydroxygallium phthalocyanine pigment showing diffraction peaks at positions where Bragg angles (2θ±0.2°) in X-ray diffraction spectrum obtained using CuKα characteristic X-ray are at least 7.3°, 16.0°, 24.9°, and 28.0° (maximum peak wavelength in spectral absorption spectrum in wavelength region of from 600 nm to 900 nm=820 nm, average particle diameter=0.12 μm, maximum particle diameter=0.2 μm, specific surface area value=60 m²/g)”

PC-2: Titanyl Phthalocyanine Pigment “Y-type titanyl phthalocyanine pigment showing diffraction peaks at positions where Bragg angles (2θ±0.2°) in X-ray diffraction spectrum obtained using CuKα characteristic X-ray are at least 9.6° and 27.3°”

BP-4: Example Compound (BP-4) of Specific Benzophenone Compound

BP-8: Example Compound (BP-8) of Specific Benzophenone Compound

Formula (5): Comparative Compound (compound represented by the following Formula (5))

Formula (6): Comparative Compound (compound represented by the following Formula (6))

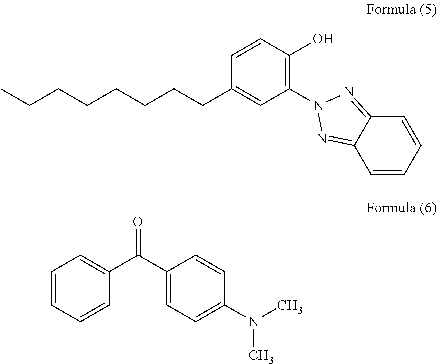 [SMILES: CCCCCCCCc1ccc(O)c(-n2nc3ccccc3n2)c1 ; CN(C)c1ccc(C(=O)c2ccccc2)cc1]

Formula (4): Electron Transport Material Represented by the Following Formula (4)

CT1-1: Example Compound (CT1-1) of Butadiene Charge Transport Material (CT1)

CT1-2: Example Compound (CT1-2) of Butadiene Charge Transport Material (CT1)

CT2-1: Example Compound (CT2-1) of Benzidine Charge Transport Material (CT2)

CT2-2: Example Compound (CT2-2) of Benzidine Charge Transport Material (CT2)

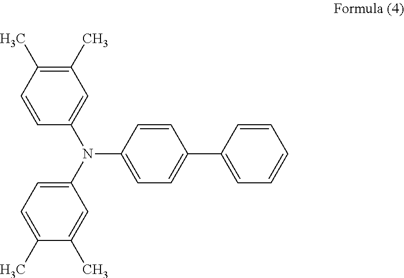 [SMILES: Cc1ccc(N(c2ccc(-c3ccccc3)cc2)c2ccc(C)c(C)c2)cc1C]

1. An electrophotographic photoreceptor comprising:
a conductive substrate;
a charge generation layer that is disposed on the conductive substrate and comprises a resin, a phthalocyanine pigment, and a compound represented by the following Formula (BP); and
a charge transport layer that is disposed on the charge generation layer and comprises a charge transport material, 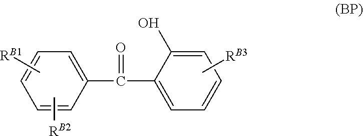
wherein R^{B1} and R^{B2} each independently represent a hydrogen atom, a halogen atom, an alkyl group having from 1 to 10 carbon atoms, an alkoxy group having from 1 to 10 carbon atoms, or an aryl group having from 6 to 10 carbon atoms,
wherein R^{B3} represents a hydrogen atom, a halogen atom, a hydroxyl group, an alkyl group having from 1 to 10 carbon atoms, or an aryl group having from 6 to 10 carbon atoms.

2. The electrophotographic photoreceptor according to claim 1,
wherein the charge transport material comprises a charge transport material represented by the following Formula (CT1) and a charge transport material represented by the following Formula (CT2), 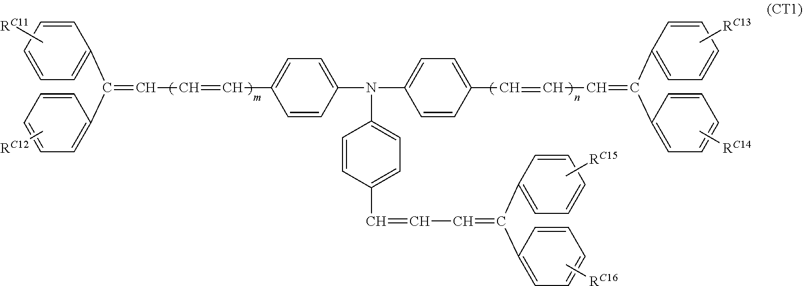
where, in the Formula (CT1), R^{C11}, R^{C12}, R^{C13}, R^{C14}, R^{C15} and R^{C16} each independently represent a hydrogen atom, a halogen atom, an alkyl group having from 1 to 20 carbon atoms, an alkoxy group having from 1 to 20 carbon atoms or an aryl group having from 6 to 30 carbon atoms, two adjacent substituents among the substituents represented by R^{C11}, R^{C12}, R^{C13}, R^{C14}, R^{C15} and R^{C16} may be bonded to each other to form a hydrocarbon ring structure, and n and m each independently represent 0, 1 or 2, and 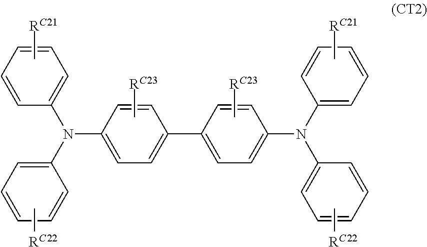
wherein in the Formula (CT2), R^{C21}, R^{C22} and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

3. The electrophotographic photoreceptor according to claim 1, wherein a content of the compound represented by the Formula (BP) in the charge generation layer is from 0.02% by weight to 20.0% by weight.

4. The electrophotographic photoreceptor according to claim 1, wherein a content of the compound represented by the Formula (BP) in the charge generation layer is from 1.0% by weight to 12.0% by weight.

5. The electrophotographic photoreceptor according to claim 1, wherein a content of the compound represented by the Formula (BP) based on 100 parts by weight of the phthalocyanine pigment is from 1 part by weight to 20 parts by weight.

6. The electrophotographic photoreceptor according to claim 1, wherein a content of the compound represented by the Formula (BP) based on 100 parts by weight of the phthalocyanine pigment is from 3 parts by weight to 10 parts by weight.

7. A process cartridge that is detachably attached to an image forming apparatus, and comprises the electrophotographic photoreceptor according to claim 1.

8. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor by a developer comprising a toner to form a toner image; and
a transfer device that transfers the toner image onto a surface of a recording medium.
